(19) United States
(12) Patent Application Publication
(10) Pub. No.: US 2014/0137898 A1
(43) Pub. Date: May 22, 2014

(54) Multi-Dosing Device

(71) Applicants: Marine Cabirol, Ludwigshafen (DE); Ian Gaylor, Cambridge Cambridgeshire (GB); Lucia Krubasik, Ludwigshafen (GB); Judith Preuschen, Ludwigshafen (DE)

(72) Inventors: Marine Cabirol, Ludwigshafen (DE); Ian Gaylor, Cambridge Cambridgeshire (GB); Lucia Krubasik, Ludwigshafen (GB); Judith Preuschen, Ludwigshafen (DE)

(73) Assignee: RECKITT BENCKISER N.V., Hoofddorp (NL)

(21) Appl. No.: 13/884,967

(22) PCT Filed: Nov. 11, 2011
(86) PCT No.: PCT/GB2011/052198

§ 371 Date: Oct. 23, 2013

(30) Foreign Application Priority Data
Nov. 12, 2010 (GB) 1019161.7

(51) Int. Cl. A47L 15/44; C11D 17/00

(52) U.S. Cl. CPC A47L 15/4472; A47L 15/4463; C11D 17/0039
USPC 134/25.2; 222/129; 510/221; 510/224

(57) ABSTRACT

The invention relates to a detergent dispensing device for an automatic washing machine. In particular the invention relates to a simple multi-dosing device.

### FIELD OF INVENTION

The invention relates to devices suitable for dosing detergents into automatic washing machines. In particular for dispensing the detergent into an automatic dishwashing or washing machine over a plurality of washing cycles

### BACKGROUND TO THE INVENTION

In automatic dishwashing machines, the detergent, whether in powder, tablet, capsule, liquid or gel form, is usually filled manually by the user into the machine, in particular into a detergent holder, before each dishwashing operation.

This filling process is inconvenient, with the problem of exact metering of the detergent and possible spillage thereof, for powder and gel detergents. Even with detergents in tablet form, wherein the problem of accurate dosing is overcome, there is still the necessity of handling the dishwashing detergent every time a dishwashing cycle is started. This is inconvenient, because consumers do not want to touch the detergent. Automatic washing detergent formulations are usually labelled as irritants.

A number of devices are known for holding unit doses of a detergent composition or additive, such as detergent tablets, and for dispensing of such unit doses into a machine.

WO 01/07703 discloses a device for the metered release of a detergent composition or additive into a dishwashing machine having a number of separate sealed chambers for holding the detergent composition or additive and means for piercing the chambers, activated by conditions within the machine.

WO 03/073906 discloses a free standing device for dispensing multiple doses of detergent into a dishwasher. The device has a plate-like construction. A round blister pack having a plurality of doses arranged around its periphery is loaded into the pack. A winder is then rotated to load mechanical energy into the device sufficient to dispense more than one dose of detergent. A thermally operated latch then moves when the device is subjected to the elevated temperatures within the dishwasher and, in cooperation with a ratchet mechanism, moves the blister pack so that the next dose of detergent is ready for dispensing. In order to dispense the detergent, either the blister pack is pierced, or the dose is ejected from its compartment within the blister pack.

WO 03/073907 discloses a similarly shaped free standing dispensing device. In order to dispense detergent, a lever is manually operated to move a blister pack either to eject the detergent from a compartment within the blister pack, or to pierce the blister pack. A door or flap initially prevents wash liquor within the machine from accessing the exposed detergent. A bi-metallic strip is provided to move the door or flap when the device is exposed to the elevated temperatures during a washing cycle to allow access of the wash liquor to the exposed detergent thereby dispensing the detergent to the machine.

The prior art devices have considerable drawbacks. They are all complicated devices that react to conditions within the automatic washing machine under operation. To do this, they all have very complicated designs. This adds both to the expense of making them initially and gives rise to reliability issues during long term use.

The environment inside automatic washing machines in use can be extremely harsh. High temperatures up to 75° C., copious amounts of water and powerful detergents make for a very challenging environment for mechanical devices, such as those described above. This is especially the case for these devices as they are designed to experience multiple wash cycles with these harsh conditions over many months or years.

It is the object of the present invention to overcome at least some of the problems above.

### SUMMARY OF THE INVENTION

A simple multi-dosing device suitable for use inside an automatic washing machine comprising a plurality of sealed and waterproof chambers, wherein each chamber comprises a detergent composition, or a significant portion thereof; wherein the device has no moving parts and wherein the chambers require manual activation to release their detergent prior to the start of the wash cycle.

A method of cleaning soiled items in an automatic washing machine comprising the multi-dosing device above.

A detergent composition suitable for use in the multi-dosing device described above.

### BRIEF DESCRIPTION OF THE DRAWINGS

FIG. 1 shows an embodiment of the present invention. In this embodiment compressed detergent tablets are contained within bubbles of a thin polymer film sheet.

FIG. 2 shows an alternative embodiment wherein the detergent tablets are contained within “blister pack” type arrangement. The bubbles are formed of a clear plastic and the backing is a metal foil.

FIG. 2a shows a profile view of the embodiment in FIG. 2.

FIG. 3 shows an alternative embodiment of the present invention.

FIG. 4 shows the activation of a chamber of the embodiment in FIG. 3.

FIG. 5 shows the embodiment of the invention shown in FIGS. 3 and 4 attached to the inside of a door of an automatic washing machine.

FIG. 6 shows a three layer sealing system comprising microcapsules. Pressure on the outside breaks the microcapsules which releases a material to disrupt the outer layers.

### DETAILED DESCRIPTION OF THE INVENTION

The invention is best described by way of several non-limiting embodiments. The invention is not limited to these specific embodiments and the skilled person will be able to devise other embodiments within the scope of the invention.

The individual features of the embodiments of the invention described may also be combined or applied to other embodiments.

For the purposes of the present invention, the term “automatic washing machine” means any automatic cleaning device. In particular it may mean an automatic ware, or dishwashing, machine, an automatic laundry washing machine or both.

The term “activation” for the purposes of the present invention means any method of preparing a chamber of the device of the present invention to release its detergent contents into the wash cycle of the automatic washing machine.

An activated chamber will release its contents to the wash cycle and an inactivated chamber will not release its contents to the wash cycle.

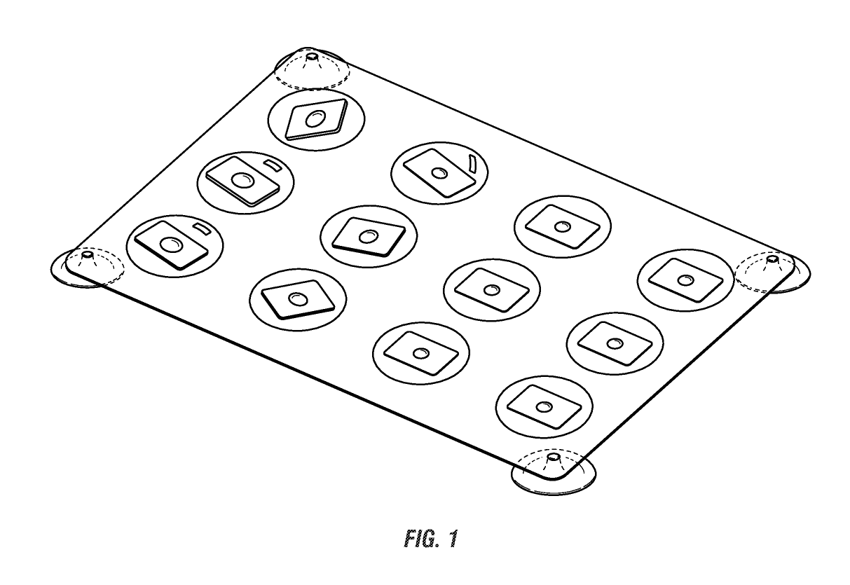

FIG. 1 shows an embodiment of the present invention. The device consists of a sheet of sealed chambers comprised of an insoluble polymer film. Each chamber contains a detergent tablet. A tablet is simply shown for convenience. The chamber also may contain any other form of detergent composition including a powder, gel or liquid, for example.

The chambers of the device are essentially in a planar arrangement.

The device in FIG. 1 resembles a sheet of “bubble-wrap”, wherein each bubble comprises a chamber. Each chamber may be large enough to contain enough detergent composition for an entire wash cycle.

The volume of the chambers can be between 1 cm³ and 50 cm³, preferably between 5 cm³ and 40 cm³, more preferably between 7.5 cm³ and 25 cm³ and most preferably between 10 cm³ and 20 cm³.

Preferably each detergent tablet may contain all the ingredients required for a single wash cycle. This means that one chamber only is required for activation prior to the start of the wash cycle.

Alternatively the chambers may contain different parts of the detergent composition. In this case two or more chambers may need activating prior to the start of the wash cycle.

For the embodiment in FIG. 1, activation means that the polymer film surrounding a chamber is pierced by the operator of the automatic washing machine prior to use.

This may be achieved by hand alone, or, for example, with a utensil such as a fork or knife.

The polymer film may comprise polyethylene, polypropylene (PP), polycarbonate, polyamide, polyvinylacetate, PET, or any other thin film polymer that is insoluble and stable to the temperature, water and pH conditions of automatic machine washing.

With the chamber pierced, water from the wash cycle can enter the pierced chamber and dissolve the detergent tablet, adding its contents to the wash liquor. The detergent tablets in the inactivated chambers are unaffected during the wash cycle as they remain sealed in their chambers. These detergent tablets remain available for future wash cycles.

Alternatively, if the chamber is activated sufficiently, the detergent contents may fall from the chamber into the machine.

The sealed detergent tablets may be released in subsequent wash cycles as required.

At each end of the sheet there are four suction cups. These are provided to attach the sheet to the inside of the automatic washing machine. The device is flexible enough to be located on most surfaces inside the machine. The surface does not need to be completely flat.

Other attachment means can be used. Including but not limited to adhesive hydrogels. For example, hydrogels based on cross-linked AMPS monomers are stable in such an environment and are described in WO 00/67810.

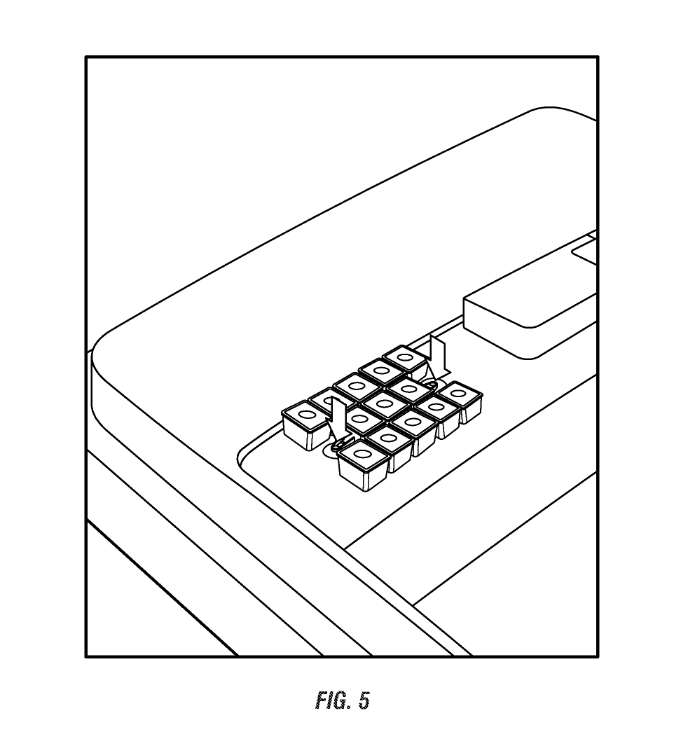

Preferably the device is attached to the door of the automatic washing machine. FIG. 5 shows an alternative embodiment of the invention attached to the door of an automatic washing machine. However the device may also be placed in other locations within the machine. The device may be flexible enough to be placed on non flat surfaces.

Detergent tablets make convenient detergent forms for the embodiment of the device in FIG. 1. However this device is not restricted to the use of detergent tablets. All forms of detergent composition known to the skilled person can be used in this device.

The device in FIG. 1 is clearly designed for single use. Once all of the detergent chambers have been activated, the device needs to be disposed of and replace with a fresh one.

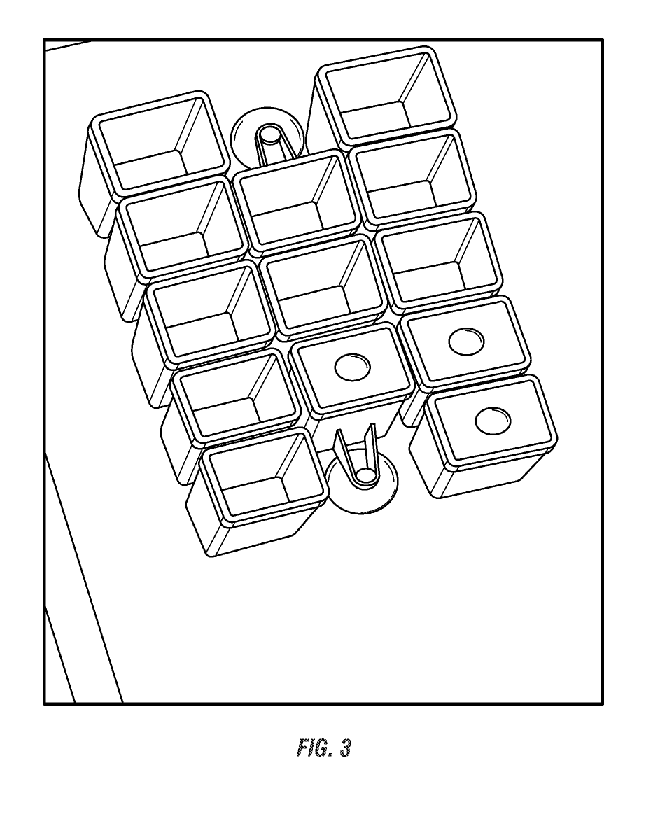

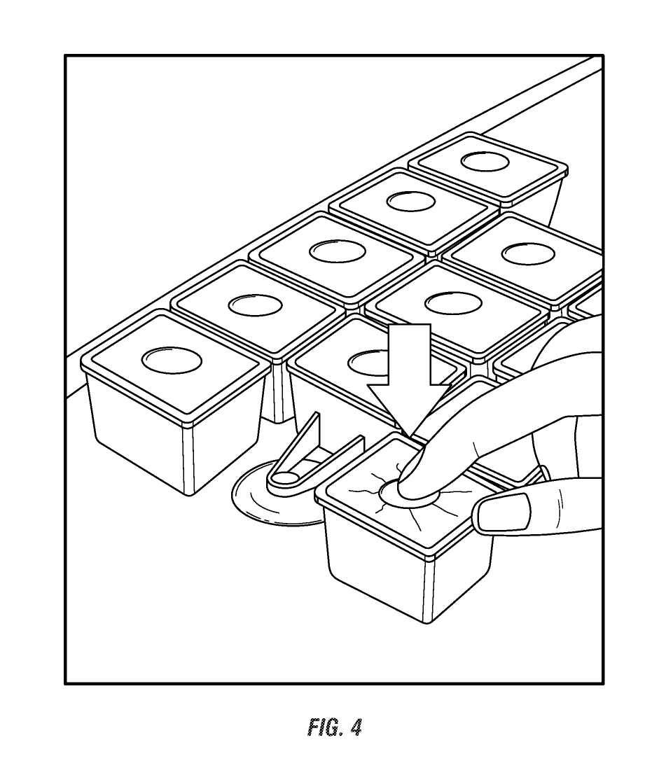

FIGS. 3 and 4 reveal an alternative embodiment of the present invention. The embodiment of the device in FIGS. 3 and 4 also comprise a sheet of detergent chambers. However, the base and sidewalls of the device are prepared from a more solid material, for example moulded plastic. The device resembles an ice-cube tray.

Only the top surface is susceptible to activation. Activation by hand is shown in FIG. 4. This top surface may comprise a polymer film as described for the embodiment in FIG. 1.

In this embodiment the device may be reusable. The device may be used multiple times. The tray portion may be recycled, refilled with detergent and the chambers resealed by another film layer. The device may also be designed for a single use and thrown away once all of the detergent chambers have been activated.

In another embodiment of the device shown in FIG. 3, the thin film coverings may be replaced by resealable openings. The openings may consist of water tight doors. In this embodiment, the device would resemble an advent calendar. The activation of the chambers the washing machine could simply consist of opening the doors of the desired chambers prior to starting the wash cycle.

In a further embodiment of the device in FIG. 3, the top surface may comprise a frangible solid. Activation would comprise breaking the frangible solid.

This frangible solid may be composed of more than one layer. For example the frangible solid may comprise a water soluble material layer and an outer layer which is water insoluble.

This may be necessary to obtain the necessary strength of seal. On activation the outer later is cracked or broken to allow the water from the wash cycle to dissolve the water soluble layer and access the detergent composition.

An example water soluble solid for use in the frangible solid would be sugar. Solid sugar could be coated with a lacquer to render it water insoluble unless the lacquer layer is punctured.

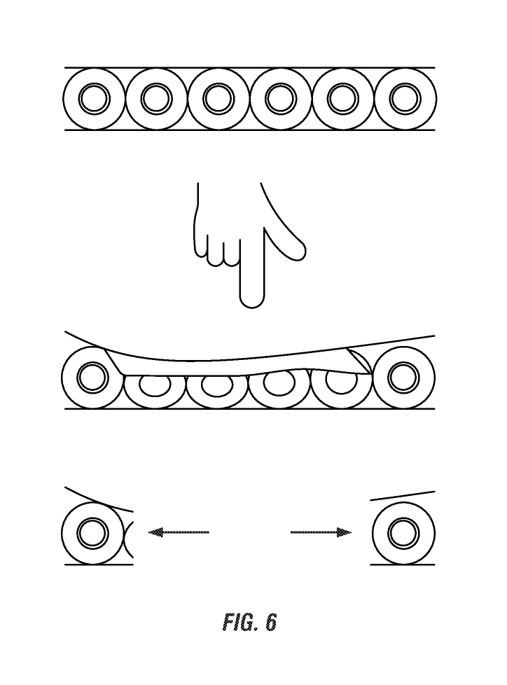

More layers can also be used in the frangible solid. FIG. 6 shows an embodiment of the frangible solid embodiment where there are three layers. The top and bottom layers comprise a water insoluble layer. The middle layer comprises micro capsules containing a solvent or other agent that dissolves the two outer layers.

When pressure is applied to the outside layer by the operator of the automatic washing machine, the microcapsules are broken and the released solvent dissolves the top and bottom layers. This embodiment is particularly preferred as the operator does not risk coming into contact with the detergent composition at all to activate the chamber. Also the operator does not need to use a sharp implement to activate.

Other features may be included in the encapsulation layer. For example a colour change function may be included to clearly identify when the capsules have been pierced.

The device for all of the embodiments described for FIG. 3 work in the same way as the embodiment in FIG. 1. Features described for the embodiment of FIG. 1 may also be applied to the embodiment of FIG. 3.

The operator of the machine activates as many of the chambers as desired for the wash cycle prior to starting the machine. Water from the wash will penetrate the activated chamber and release the detergent composition into the wash.

Should the dissolution of the detergents in the activated chamber prove problematic, which may be the case for detergents compositions with low solubility, another embodiment of the device could be envisaged. In this embodiment, the polymer film or frangible solid may be replaced by a film of natural rubber or other elastic film under tension. In this embodiment the device could be constructed in such a way that the rubber film is stretched over the detergent composition. The sidewalls of the chambers would be much lower than in FIG. 3.

With this arrangement, once activated by being pierced the rubber film would retract from covering the detergent. Without the stretched rubber film, the detergent composition would fall out of the chamber if the device was moved through 90°. (In this embodiment in particular, the preferred location is on the door of the automatic washing machine.) This would then cause the detergent to fall into the floor of the dishwasher. This would enhance the solubility time for the detergent composition.

For this embodiment it would be preferred to use detergent tablets that have an off-centre centre of gravity. This would aid the tablets falling/toppling from the device. This can be achieved by making the tablets in a non regular shape or having areas of higher density in normal oblong tablets.

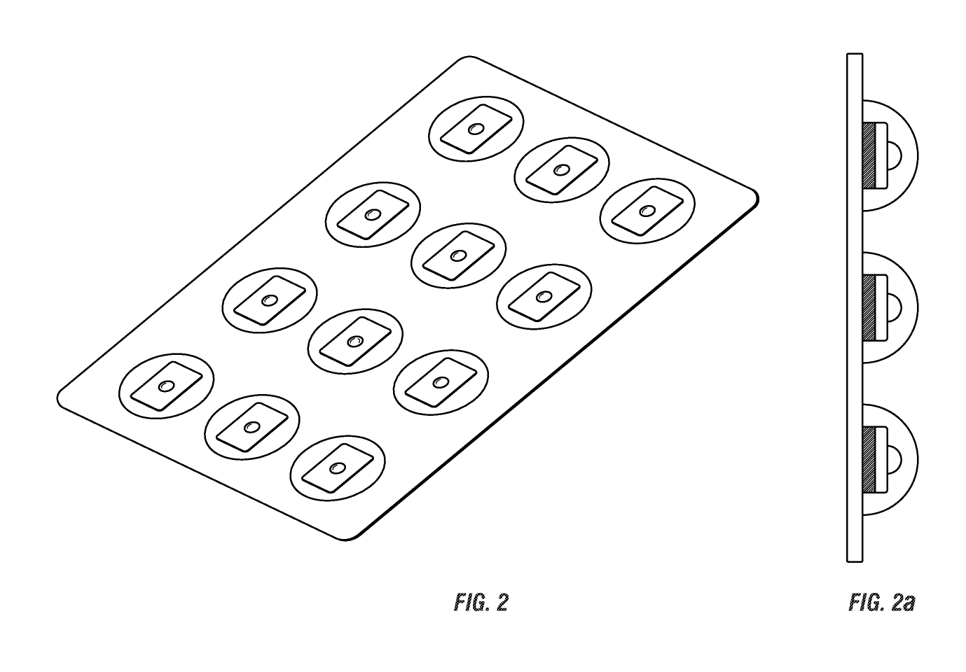

FIG. 2 shows another embodiment of the present invention. In this embodiment the device comprises a clear plastic sheet with a series of moulds. In each mould would be placed a detergent. A metal film runs across the back sealing the chambers. This embodiment resembles a blister pack for medical tablets/capsules.

FIG. 2a shows a profile view of FIG. 2.

Before starting the wash cycle, the operator would activate the chamber desired by applying pressure to the mould. This would deform and apply pressure to the detergent composition, pushing it up against the metal film. The metal film will then perforate and release the composition.

This embodiment is desirable both as it prevents contact between the detergent composition and the operator and that it frees the detergent composition from the chamber immediately.

Features described for the embodiments of FIGS. 1 and 3 may also be applied to the embodiment of FIG. 2.

The devices of the present invention are preferably used in automatic dish-washing machines.

### Detergent Compositions

The devices of the present invention can be used with any detergent composition form known in the art. Possible forms include tablets, powders, gels, pastes and liquids. The detergent compositions may also comprise a mixture of two or more forms. For example the composition may comprise a gel component and a free powder component. The particles of the present invention may be contained within the gel portion or the powder portion of the detergent composition, or contained within both portions.

Tablets may be homogeneous or composed of multi-layers. If the tablets are multi-layered then different layers may comprise different parts of the detergent composition. This may be done to increase stability or increase performance, or both. The particles of the present invention may be contained within one or more layers of the tablets.

The detergent compositions may be housed in PVOH rigid capsules or PVOH film blisters. These PVOH capsules or blisters may have a single compartment or may be multi-compartment.

Multi-compartment blisters or capsules may have different portions of the composition in each compartment, or the same composition in each compartment. The distinct regions/or compartments may contain any proportion of the total amount of ingredients as desired.

The PVOH capsules or film blisters may be filled with tablets, powders, gels, pastes or liquids, or combinations of these.

The detergent compositions may comprise any ingredients known in the art. These may include components such as builders, polymers, surfactants, enzymes, bleach, bleach additives, bleach activation catalysts and anti-corrosion additives, dyes and fragrances, thickeners.

1. A multi-dosing device, suitable for use inside a washing machine, comprising:
a plurality of sealed and waterproof chambers, wherein at least a portion of the chambers contain therein a detergent composition;
wherein the device has no moving parts; and
wherein the chambers having detergent composition require manual activation to release their detergent composition prior to the start of a wash cycle.

2. The multi-dosing device according to claim 1, wherein the chambers are arranged in a planar arrangement.

3. The multi-dosing device according to claim 1, wherein at least a portion of at least a portion of the sealed chambers comprise an insoluble thin film.

4. The multi-dosing device according to claim 3, wherein the insoluble thin film comprises one or both of a metal foil and a polymer.

5. The multi-dosing device according to claim 3, wherein the insoluble thin film comprises polymer selected from the group consisting of natural rubber or polyethylene, polypropylene, polyamide, polycarbonate, polyamide, polyvinylacetate (PVA) and PET.

6. The multi-dosing device according to claim 1, wherein at least a portion of the chambers consist essentially of an insoluble thin film.

7. The multi-dosing device according to claim 1, wherein at least a portion of at least a portion of the sealed chambers comprise a frangible solid.

8. The multi-dosing device according to claim 7, wherein the chambers comprising a frangible solid comprises multiple layers of frangible solid.

9. The multi-dosing device according to claim 7, wherein the frangible layer comprises a water soluble solid with a waterproof coating.

10. The multi-dosing device according to claim 9, wherein the water soluble solid is a sugar compound.

11. The multi-dosing device according to claim 7, wherein the frangible solid comprises an encapsulated solvent layer.

12. The multi-dosing device according to claim 1 further comprising an attachment means to fix at least a portion of the device to the inside of a washing machine.

13. The multi-dosing device according to claim 12, wherein the attachment means comprises suction cups.

14. The multi-dosing device according to claim 1, wherein the activation of at least a portion of the chambers is manually carried out by a person.

15. The multi-dosing device according to claim 1, wherein the activation of at least a portion of the chambers is by piercing.

16.-17. (canceled)

18. A method of washing soiled items in a washing machine comprising:
using a multi-dosing device according to claim 1; and
activating one or more of the sealed chambers prior to use in a wash cycle.

19. The method according to claim 18, wherein at least a portion of the soiled items comprise tableware.

20. A detergent composition for use in the multi-dosing device of claim 1.

21. (canceled)

22. The detergent composition of claim 20, wherein the detergent composition is in the form selected from the group consisting of a tablet, capsule, gel, powder and liquid.

23. (canceled)

24. The multi-dosing device according to claim 12, wherein the attachment means comprises adhesive hydrogel strips.

25. The multi-dosing device of claim 1, suitable for use inside an automatic washing machine, wherein each of the sealed and waterproof chambers comprise a detergent composition.

26. The multi-dosing device according to claim 25 further comprising an attachment means to fix the device to the inside of an automatic washing machine.

27. The multi-dosing device according to claim 25, wherein the activation of each of the chambers is manually carried out by a person.

28. The multi-dosing device according to claim 25, wherein the activation of each of the chambers is by piercing the chamber.
